(19) United States
(12) Patent Application Publication
(10) Pub. No.: US 2016/0329060 A1
(43) Pub. Date: Nov. 10, 2016

(54) SPEECH PROCESSING APPARATUS, SPEECH PROCESSING SYSTEM, SPEECH PROCESSING METHOD, AND PROGRAM PRODUCT FOR SPEECH PROCESSING

(71) Applicant: DENSO CORPORATION, Kariya-City (JP)

(72) Inventors: Masaya ITO, Kariya-city (JP); Yoshitaka OZAKI, Kariya-city (JP); Keisaku HAYASHI, Kariya-city (JP); Hiroki UKAI, Kariya-city (JP)

(73) Assignee: DENSO CORPORATION, Kariya-city, Aichi-pref. (JP)

(21) Appl. No.: 15/108,739

(22) PCT Filed: Dec. 11, 2014
(86) PCT No.: PCT/JP2014/006172

§ 371 Date: Jun. 28, 2016

(30) Foreign Application Priority Data
Jan. 6, 2014 (JP) 2014-000285

(51) Int. Cl. G10L 19/22; H04M 1/725; G10L 15/22; H04M 1/60; G10L 21/0208; G10L 21/0316

(52) U.S. Cl. CPC G10L 19/22; G10L 21/0208; G10L 21/0316; G10L 15/22; H04M 1/6091; H04M 1/7253; H04M 1/72561; H04M 1/72558; G10L 2015/223; H04M 2250/02; H04M 2207/18; H04M 2201/40

(57) ABSTRACT

A speech processing apparatus performs predetermined speech processing on speech data that is acquired and then transmitted to an external handheld terminal, using a speech processing section. The speech processing section can switch first speech processing used in phone calls and second speech processing used in other than phone calls as the predetermined speech processing.

### CROSS REFERENCE TO RELATED APPLICATION

The present application is based on Japanese Patent Application No. 2014-285 filed on Jan. 6, 2014, the disclosure of which is incorporated herein by reference.

### TECHNICAL FIELD

The present disclosure elates to a speech processing apparatus, speech processing system, speech processing method, and program product for speech processing.

### BACKGROUND ART

There is lately prevailing a technique that implements a so-called hands-free phone call, permitting a phone call without holding a handheld terminal with a hand, by connecting (i) a vehicular device in a vehicle, and (ii) the handheld terminal, to communicate with each other (refer to Patent literature 1). Such a hands-free phone call technique uses a Bluetooth (registered trademark) hands-free profile (HFP) adopted in many vehicular devices as a communications protocol. The vehicular devices perform speech processing on speech data to optimize; then, the speech data is transmitted to the handheld terminal.

### PRIOR ART LITERATURES

### Patent Literature

Patent literature 1: JP 2006-238148 A

### SUMMARY OF INVENTION

There is lately developed a technique that runs an application while allowing a vehicular device and a handheld terminal to link up with each other. The technique can run not only a so-called phone call application enabling a hands-free phone call but also an application for any purpose other than phone calls, for example, a search application that utilizes speech recognition of recognizing speech uttered by a user.

The search application allows the vehicular device to transmit acquired speech data to an external center server via the handheld terminal. The center server performs speech recognition based on the acquired speech data, and returns a result of search for the speech to the vehicular device. However, even when transmitting the speech data to the handheld terminal during searching using speech recognition, the vehicular device conventionally subjects the speech data to speech processing (such as noise cancel processing, echo cancel processing, gain control processing) that is identical to that during making hands-free phone calls. The speech processing optimal to phone calls and the speech processing optimal to speech recognition are different from each other. In hands-free phone calls, speech processing is performed to thin sounds to leave sounds of frequencies audible by a human being. If the same processing as the speech processing is performed for speech recognition, speech waves necessary for speech recognition are distorted to degrade a recognition rate.

An object of the present disclosure is to provide a speech processing apparatus capable of optimally performing both speech processing for phone calls and speech processing for any purpose other than phone calls, a speech processing system including the speech processing apparatus, a speech processing method to be implemented in the speech processing apparatus, and a program product for speech processing that is run while being installed in the speech processing apparatus.

According to an example of the present disclosure, predetermined speech processing is applied to speech data when the speech data is to be transmitted to an external handheld terminal. The predetermined speech processing can be provided as switching (i) first speech processing used in phone calls and (ii) second speech processing for other than phone calls. This enables the first speech processing used in phone calls and the second speech processing used in other than phone calls to switch to each other according to an application executed, thereby executing appropriately each of the first speech processing used in phone calls and the second speech processing used in other than phone calls.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram schematically illustrating an example of a configuration of a speech processing system of an embodiment;

FIG. 2 is a diagram schematically illustrating an example of a configuration of a speech processing apparatus;

FIG. 3 is a diagram schematically illustrating an example of a configuration of a handheld terminal;

FIG. 4 is a flowchart mentioning an example of the contents of control to be performed in order to run a speech application;

FIG. 5 is a diagram schematically showing a state where the speech processing apparatus and handheld terminal link up with each other so as to run an application;

FIG. 6 is a flowchart mentioning an example of the contents of control to be performed in order to run a speech recognition search application; and

FIG. 7 is a diagram illustrating an outline configuration of a speech processing system of a modification of the embodiment (part 1);

FIG. 8 is a diagram illustrating an outline configuration of a speech processing system of a modification of the embodiment (part 2);

FIG. 9 is a diagram illustrating an outline configuration of a speech processing system of a modification of the embodiment (part 3); and

FIG. 10 is a diagram illustrating an outline configuration of a speech processing system of a modification of the embodiment (part 4).

### EMBODIMENTS FOR CARRYING OUT INVENTION

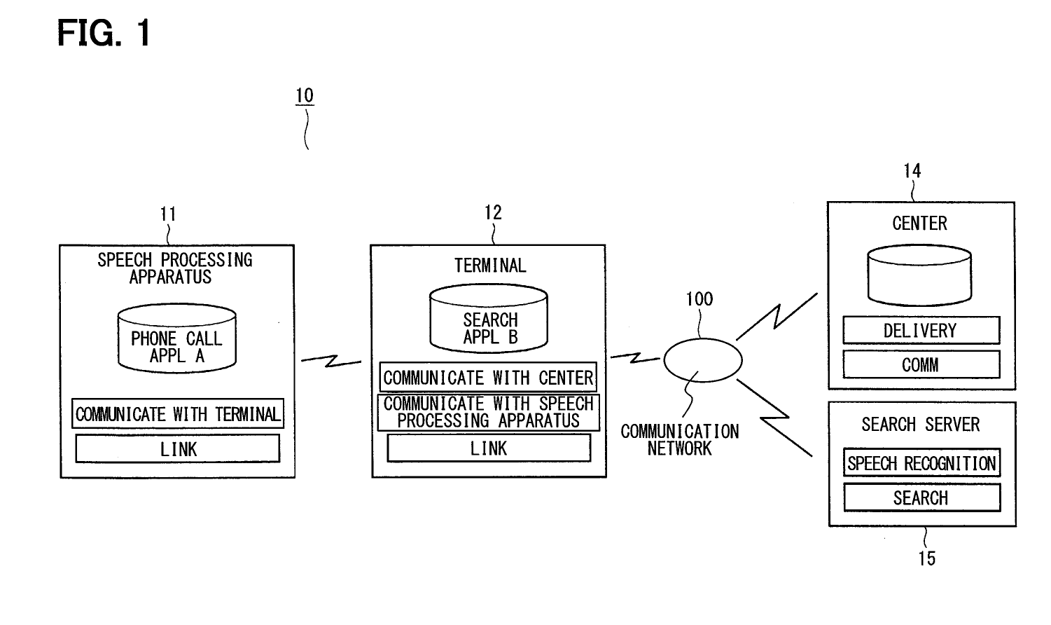

Referring to the drawings, an embodiment of the present disclosure will be described below. As in FIG. 1, a speech processing system 10 includes a speech processing apparatus 11 and a handheld terminal 12. The speech processing apparatus 11 includes a navigation unit mounted in a vehicle. A phone call application A is installed in the speech processing apparatus 11. The phone call application A is to implement a so-called hands-free phone call function (hands-free telephone conversation function) which allows a user to make a phone call (telephone conversation) without holding the handheld terminal 12 using the hand. The handheld terminal 12 may be a handheld communication terminal owned by an occupant of a vehicle. When carried into a vehicle compartment, the handheld terminal 12 is connected to the speech processing apparatus 11 so as to communicate with the speech processing apparatus 11 according to a Bluetooth (registered trademark) communication standard that is an example of a short-range wireless communication standard.

The speech processing apparatus 11 and handheld terminal 12 are connected to an external delivery center 14 over a communication network 100 to acquire various applications that are delivered from the delivery center 14. The delivery center 14 stores, in addition to the phone call application A, a speech recognition search application B that renders a search service based on speech recognition of recognizing speech uttered by a user, an application that implements Internet radio, an application that renders a music delivery service, and other various applications. On receiving a delivery request for an application from an external terminal or apparatus, the delivery center 14 delivers the application to the request source over the communication network 100. The application to be delivered from the delivery center 14 includes various data items necessary to run the application.

The speech processing apparatus 11 and handheld terminal 12 can be connected to a speech recognition search server 15 (search server 15) over the communication network 100. The speech recognition search server 15 stores known dictionary data that is necessary for speech recognition processing, and data for search processing that is necessary for search processing. The data for search processing contains, in addition to map data, data items representing names and places of stores and institutions existent on a map.

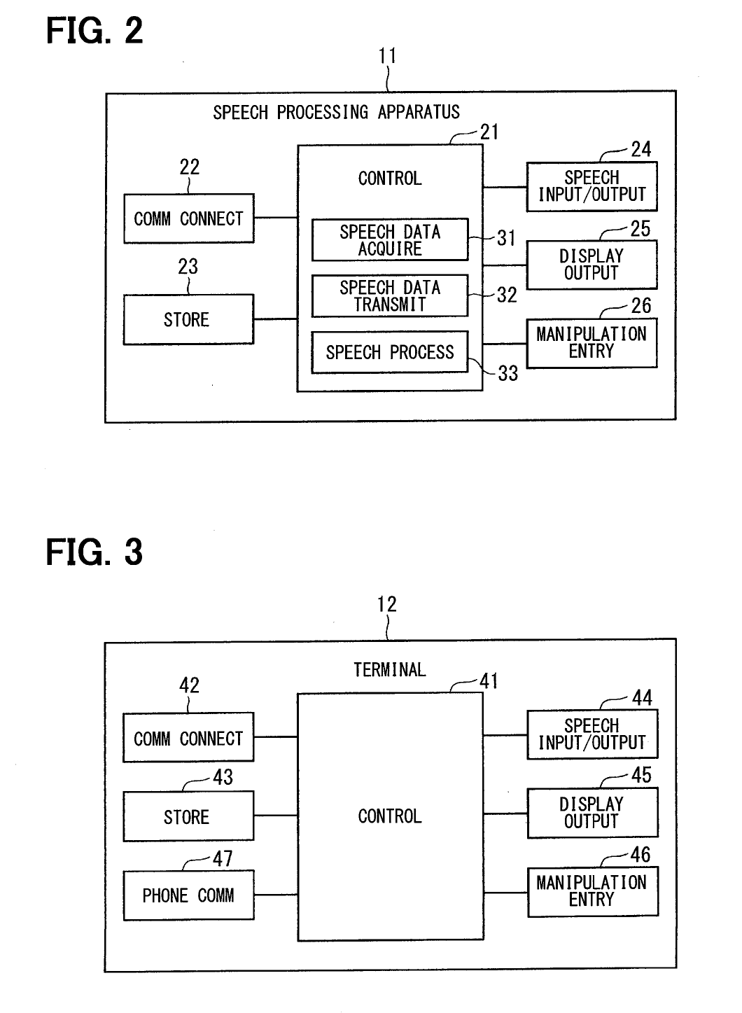

Referring to FIG. 2, the configuration of the speech processing apparatus 11 will be described below. The speech processing apparatus 11 includes a control circuit 21, a communication connection unit 22, a memory unit 23, a speech input/output unit 24, a display output unit 25, and a manipulation entry unit 26. The control circuit 21 includes a known microcomputer including a CPU, RAM, ROM, and I/O bus that are unshown. The control circuit 21 controls the overall operation of the speech processing apparatus 11 according to various computer programs stored in the ROM or memory unit 23. In the present embodiment, the control circuit 21 runs a speech processing program that is a computer program so as to virtually implement a speech data acquisition processing section 31, a speech data transmission processing section 32, and a speech processing section 33, by software. Part or the whole of the function of each of the processing sections may be provided as a hardware component.

The communication connection unit 22 includes a wireless communication module, establishes a wireless communication channel with a communication connection unit 42 included in the handheld terminal 12, and communicates various data items to or from the handheld terminal 12 on the wireless communication channel. The communication connection unit 22 supports various communications protocols including a profile for a hands-free phone call (hands-free profile (HFP)) and a profile for data communication.

The memory unit 23 includes a computer-readable non-transitory nonvolatile storage medium such as a hard disk drive, and stores various programs (program products containing instructions) including a linkage application that implements a linkage function of running an application while linking up with an external apparatus or terminal, and various data items to be used by the programs. The memory unit 23 stores various data items necessary for speech recognition processing, such as known dictionary data to be used to perform speech recognition on acquired speech data. The speech processing apparatus 11 can therefore perform speech recognition processing by itself without the aid of the speech recognition search server 15.

The speech input/output unit 24, which is connected to a microphone and loudspeaker (unshown), has a known speech input function and speech output function. If the phone call application A is invoked while the handheld terminal 12 is connected to the speech processing apparatus 11 to communicate with the speech processing apparatus, the speech input/output unit 24 can transmit speech data corresponding to speech inputted through the microphone, to the handheld terminal 12, and can output speech through the loudspeaker based on speech data received from the handheld terminal 12. The speech processing apparatus 11 thereby collaborates with the handheld terminal 12 in implementing a so-called hands-free phone call.

The display output unit 25 includes a liquid crystal display or organic electroluminescent (EL) display, and displays various informations in response to a display command signal from the control circuit 21. Touch panel switches of a known pressure-sensitive type, electromagnetic induction type, electrostatic capacity type, or type achieved by combining these types are arranged on the screen of the display output unit 25. Various screen views including an input interface such as a manipulation entry screen view through which a manipulation is entered in an application and an output interface such as an output screen view through which the contents of run of an application or an outcome of the run is outputted are displayed on the display output unit 25.

The manipulation entry unit 26 includes various switches such as touch panel switches arranged on the screen of the display output unit 25 and mechanical switches disposed on the perimeter of the display output unit 25. The manipulation entry unit 26 outputs a manipulation sense signal to the control circuit 21 according to a user's manipulation performed on any of various switches. The control circuit 21 analyzes the manipulation sense signal entered at the manipulation entry unit 26, identifies the contents of the user's manipulation, and performs any of various processing based on the identified contents of the manipulation. The speech processing apparatus 11 includes a known position specification unit (unshown) that specifies the current position of the speech processing apparatus 11 based on satellite radio waves received from positioning satellites (unshown).

The speech data acquisition processing section 31, which may be referred to as a speech data acquisition section, device, or means, produces speech data representing speech that is acquired when the speech is inputted through the microphone of the speech input/output unit 24.

The speech data transmission processing section 32 may be referred to as a speech data transmission section, device, or means. The speech data transmission processing section 32 transmits speech data, which is acquired by the speech data acquisition processing section 31, to the external handheld terminal 12 on a communication channel established by the communication connection unit 22. The speech data transmission processing section 32 transmits speech data for a phone call and speech data for any purpose other than a phone call according to the same communications protocol. In the embodiment, a profile for a hands-free phone call (HFP) that is a Bluetooth communication standard is adopted as the same communications protocol. However, an adoptable communications protocol is not limited to the HFP.

The speech processing section 33, which may be referred to as a speech processing device or means, performs predetermined speech processing on speech data that is transmitted from the speech data transmission processing section 32. The speech processing section 33 performs as the speech processing either speech processing for a phone call (first speech processing) or speech processing for speech recognition search that is an example of speech processing for any purpose other than a phone call (second speech processing). The speech processing for a phone call is processing of thinning sounds to leave sounds of frequencies audible by a human being, and includes noise cancel processing for a phone call, echo cancel processing for a phone call, and gain control processing for a phone call. According to the speech processing for a phone call, sounds other than sounds of audible frequencies are fully or almost fully cancelled. In contrast, the speech processing for speech recognition search is processing for thinning sounds to such an extent that speech recognition can be achieved with sounds of audible frequencies left intact, and includes noise cancel processing for speech recognition search, echo cancel processing for speech recognition search, and gain control processing for speech recognition search. According to the speech processing for speech recognition search, sounds other than sounds of audible frequencies are not cancelled but left to some extent.

Basically, speech processing for a phone call rather than speech processing for speech recognition search can apply reliable noise cancel, echo cancel, or gain control to speech data. In contrast, in speech processing for speech recognition search, since raw speech that is as close as possible to speech uttered by a user has to be acquired, relatively loose noise cancel, echo cancel, or gain control is applied to speech data. Namely, the speech processing for speech recognition search is requested to prevent, to the greatest possible extent, original speech information (speech waves) from being changed.

Gain control in speech processing for a phone call decreases a gain for a high frequency band and low frequency band, within which sounds are hardly heard by a human being, out of frequency bands of speech data, and amplifies a gain for an intermediate frequency band within which sounds are easily heard. However, when this speech processing is performed on speech data for speech recognition search, original speech waves are distorted. The speech processing is therefore unsuitable for speech recognition. The speech wave (frequency) varies depending on a vowel or consonant. If the original speech waves are distorted, it is very hard to recognize speech. Gain control in speech processing for speech recognition therefore preferably performs processing that leaves speech waves which are as close as possible to original speech waves, that is, speech processing that leaves speech waves in a form closer to an original form than in a form attained through speech processing for a phone call by, for example, modifying set values (parameters) for a high frequency band and low frequency band for which a gain is decreased, or appropriately adjusting a degree to which the gain is decreased.

Next, referring to FIG. 3, the configuration of the handheld terminal 12 will be described below. The handheld terminal 12 includes a control circuit 41, a communication connection unit 42, a memory unit 43, a speech input/output unit 44, a display output unit 45, a manipulation entry unit 46, and a telephone communication unit 47. The control circuit 41 includes a known microcomputer including a CPU, RAM, ROM, and I/O bus (unshown). In the embodiment, the control circuit 41 controls the overall operation of the handheld terminal 12 according to computer programs stored in the ROM or memory unit 43. Part or the whole of the functions of the control circuit 41 can be implemented in hardware components.

The communication connection unit 42 includes a wireless communication module, establishes a wireless communication channel with the communication connection unit 22 of the speech processing apparatus 11, and communicates various data items to or from the speech processing apparatus 11 on the wireless communication channel. The communication connection unit 42 supports various communication protocols including a profile for a hands-free phone call (HFP) and a profile for data communication. The memory unit 43, which includes a computer-readable non-transitory nonvolatile storage medium such as a memory card, stores various programs (program products containing instructions) including (i) various computer programs, (ii) application programs and (iii) a linkage application that implements a linkage function of running an application while linking up with an external apparatus or terminal. The memory unit 43 also stores various data items to be used by the programs.

The speech input/output unit 44 is connected to a microphone and loudspeaker (unshown), and has a known speech input function and speech output function. If the phone call application A is invoked in the speech processing apparatus 11 while the speech processing apparatus 11 is connected to the handheld terminal 12 so as to communicate with the handheld terminal 12, the speech input/output unit 44 can transmit speech data, which represents speech inputted at a handheld terminal of a calling/called party (unshown), to the speech processing apparatus 11, and can transmit speech data, which is received from the speech processing apparatus 11, to the handheld terminal of the calling/called party. The handheld terminal 12 thereby collaborates with the speech processing apparatus 11 in implementing a so-called hands-free phone call. When the speech processing apparatus 11 is not connected to the handheld terminal 12 and cannot therefor communicate with the handheld terminal, the speech input/output unit 44 outputs speech of an ongoing call, which is inputted through the microphone, to the control circuit 41, or outputs speech of an incoming call, which is inputted from the control circuit 41, through the loudspeaker. The handheld terminal 12 can thereby implement a phone call function by itself.

The display output unit 45 includes a liquid crystal display or organic electroluminescent (EL) display, and displays various information in response to a display command signal sent from the control circuit 41. Touch panel switches of a known pressure sensitive type, electromagnetic induction type, electrostatic capacity type, or type achieved by combining these types are arranged on the screen of the display output unit 45. Various screen views including an input interface such as a manipulation entry screen view through which a manipulation can be entered in an application and an output interface such as an output screen view through which the contents of run of an application and an outcome of the run are outputted are displayed on the display output unit 45.

The manipulation entry unit 46 includes various switches such as touch panel switches arranged on the screen of the display output unit 45 and mechanical switches disposed on the perimeter of the display output unit 45. The manipulation entry unit 46 outputs a manipulation sense signal to the control circuit 41 according to a manipulation performed on any of various switches by a user. The control circuit 41 analyzes the manipulation sense signal inputted from the manipulation entry unit 46, identifies the contents of the user's manipulation, and performs any of various processing based on the identified contents of the manipulation.

The telephone communication unit 47 establishes a wireless telephone communication channel with the communication network 100, and performs telephone communication on the telephone communication channel. The communication network 100 includes cellular phone base stations and base station control apparatuses (unshown), and other facilities that provide cellular phone communication services which employ a known public network. The control circuit 41 is connected to the delivery center 14 or speech recognition search server 15, which is connected onto the communication network 100, via the telephone communication unit 47.

Next, a description will be made of an example of the contents of control to be performed in the speech processing system 10, which has the foregoing configuration, in order to run the phone call application A.

It is noted that a flowchart or the processing of the flowchart in the present application includes sections (also referred to as steps), each of which is represented, for instance, as A1, B1, C1, D1, or E1. Further, each section can be divided into several sub-sections while several sections can be combined into a single section. Furthermore, each of thus configured sections can be also referred to as a device, module, or means. Each or any combination of sections explained in the above can be achieved as (i) a software section in combination with a hardware unit (e.g., computer) or (ii) a hardware section, including or not including a function of a related apparatus; furthermore, the hardware section (e.g., integrated circuit, hard-wired logic circuit) may be constructed inside of a microcomputer.

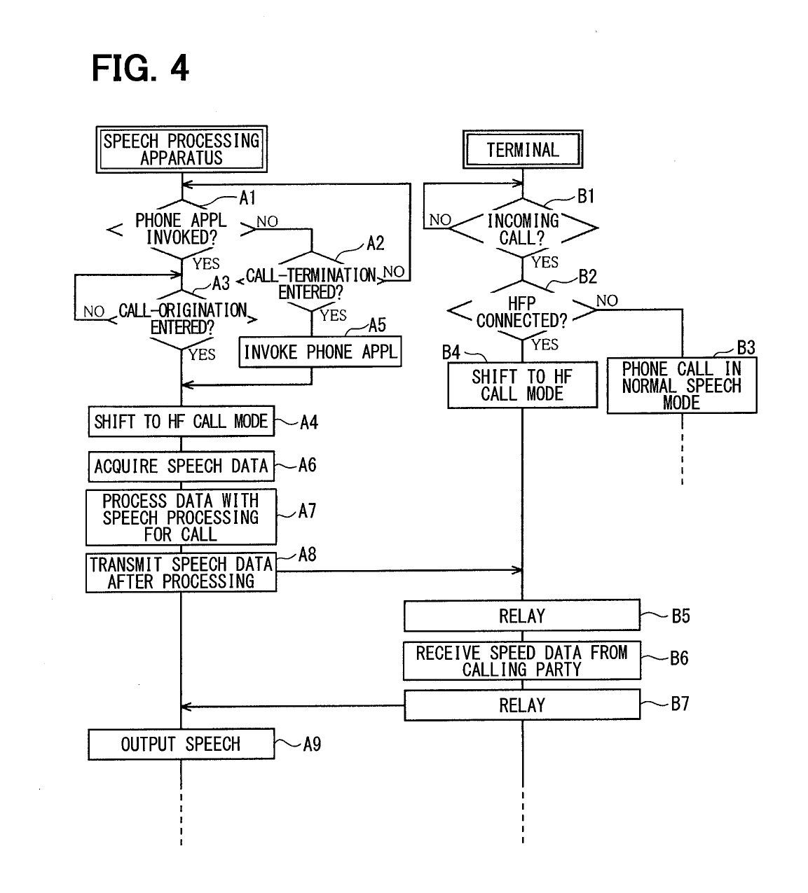

As in FIG. 4, the speech processing apparatus 11 monitors whether the phone call application A is invoked by the speech processing apparatus 11 (A1) and whether a call-termination manipulation is entered at the external handheld terminal 12 (A2). If the phone call application A is invoked (A1: YES), the speech processing apparatus 1 monitors whether a user has entered a call-origination manipulation in the phone call application A (A3). The call-origination manipulation is an example of a voluntary manipulation in the phone call application A and is to originate an outgoing call to an external handheld terminal. When the call-origination manipulation is entered (A3: YES), the speech processing apparatus 11 shifts from a normal mode to a hands-free phone call mode (A4). When the phone call application A is not invoked, if a call-termination manipulation is entered (A2: YES), the speech processing apparatus 11 invokes the phone call application (A5). The speech processing apparatus 11 then shifts from the normal mode to the hands-free phone call mode (A4). The call-termination manipulation is an example of a non-voluntary manipulation in the phone call application A and is to receive an incoming call from the external handheld terminal. When an incoming call is received from the external handheld terminal and the normal mode is shifted to the hands-free phone call mode, the handheld terminal 12 inputs the call-termination manipulation to the speech processing apparatus 11.

In the hands-free phone call mode, the speech processing apparatus 11 can establish a wireless communication channel under HFP with the handheld terminal 12, can transmit speech data, which represents speech inputted through the microphone, to the handheld terminal 12, and can output speech through the loudspeaker based on the speech data received from the handheld terminal 12.

On receiving an incoming call from an external handheld terminal (unshown) (B1: YES), the handheld terminal 12 checks to see if the wireless communication channel under HFP is established with the speech processing apparatus 11 (B2). If the wireless communication channel under HFP is not established with the speech processing apparatus 11 (B2: NO), the handheld terminal 12 implements a phone call by itself in the normal speech mode (B3). Namely, the handheld terminal 12 makes a normal phone call with the handheld terminal of a calling/called party.

If the wireless communication channel under HFP is established with the speech processing apparatus 11 (B2: YES), the handheld terminal 12 shifts from the normal phone call mode to the hands-free phone call mode (B4). In the hands-free phone call mode, the handheld terminal 12 can transmit speech data, which represents speech inputted from the handheld terminal of a calling/called party (unshown), to the speech processing apparatus 11 on the wireless communication channel under HFP established with the speech processing apparatus 11, and can transmit speech data, which is received from the speech processing apparatus 11, to the handheld terminal of the calling/called party. When both the speech processing apparatus 11 and handheld terminal 12 enter the hands-free phone call mode, the speech processing system 10 can make a so-called hands-free phone call.

When having entered the hands-free phone call mode, the speech processing apparatus 11 uses the speech data acquisition processing section 31 to acquire speech data (A6), and uses the speech processing section 33 to perform speech processing for a phone call on the acquired speech data (A7). The speech processing apparatus 11 has sensed a voluntary or non-voluntary manipulation in the phone call application A, and has therefore recognized that an application being run is the phone call application A. The speech processing apparatus 11 thereby changes speech processing, which is performed on speech data, into the speech processing for a phone call. The speech processing apparatus 11 then transmits the speech data, which has undergone the speech processing for a phone call, to the handheld terminal 12 (A8). Step A6 is an example of a speech data acquisition step, step A7 is an example of a speech processing step, and step A8 is an example of a speech data transmission step.

The handheld terminal 12 transmits speech data, which is received from the speech processing apparatus 11, to the handheld terminal of the calling/called party

(B5). In addition, the handheld terminal 12 receives speech data from the handheld terminal of the calling/called party (B6), and in turn transmits the speech data to the speech processing apparatus 11 (B7). The speech processing apparatus 11 receives the speech data from the handheld terminal 12, and in turn outputs speech through the loudspeaker based on the speech data (A9). Eventually, speech of an incoming call received from the handheld terminal of the calling/called party is outputted from the speech processing apparatus 11. Speech data of an outgoing call and speech data of an incoming call are thus appropriately transmitted or received between the speech processing apparatus 11 and the handheld terminal of the calling/called party via the handheld terminal 12, whereby a so-called hands-free phone call is achieved. When the speech processing apparatus 11 senses a voluntary or non-voluntary manipulation in the phone call application A, speech processing for a phone call is performed on speech data that is transmitted from the speech processing apparatus 11 to the handheld terminal 12. The hands-free phone call is continued until a phone call is cleared by the speech processing apparatus 11 or the handheld terminal of the calling/called party.

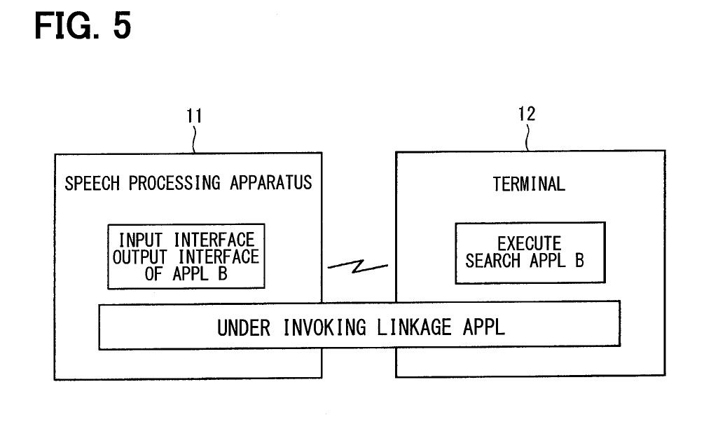

An example of the contents of control to run a speech recognition search application B (search application B) in the speech processing system 10 having the aforesaid configuration will be described. As in FIG. 5, when the handheld terminal 12 is connected to the speech processing apparatus 11 so as to communicate with the speech processing apparatus and a linkage application is invoked in each of the speech processing apparatus 11 and handheld terminal 12, the speech recognition search application B installed in the handheld terminal 12 is run by the handheld terminal 12. An input interface and output interface for the speech recognition search application B are provided by the speech processing apparatus 11. The speech recognition search application B is preferably run while a vehicle is not travelling, so as not to impose an adverse effect on traveling.

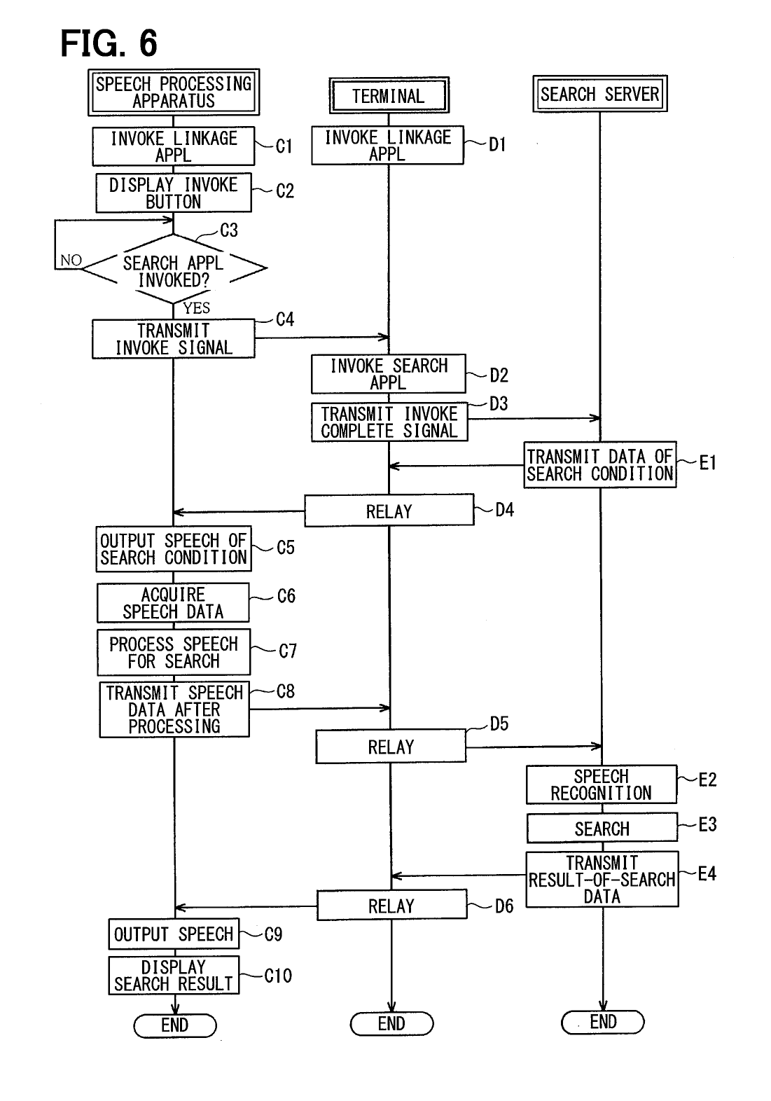

As in FIG. 6, when the linkage application is invoked in each of the speech processing apparatus 11 and handheld terminal 12 (C1 and D1), an Invoke button for the application installed in the handheld terminal 12 is displayed on the speech processing apparatus 11 (C2). The Invoke button is an example of an input interface. When the Invoke button for the speech recognition search application B is manipulated (C3: YES), the speech processing apparatus 11 transmits an invoking command signal for the speech recognition search application B to the handheld terminal 12 (C4). At this time, the speech processing apparatus 11 also transmits current position information, which represents the current position of the speech processing apparatus 11 obtained by the position specification unit, to the handheld terminal 12.

On receiving the invoking command signal for the speech recognition search application B, the handheld terminal 12 invokes the speech recognition search application B (D2). The handheld terminal 12 then transmits an invoking completion signal, which signifies that the speech recognition search application B has been invoked, to the speech recognition search server 15 (D3). At this time, the handheld terminal 12 also transmits current position information, which is received from the speech processing apparatus 11, to the speech recognition search server 15.

The speech recognition search server 15 receives the invoking completion signal for the speech recognition search application B, and in turn transmits speech data for search condition acquisition to the handheld terminal 12 (E1). As the speech data for search condition acquisition, for example, message data saying “What can I do for you?” is designated. The handheld terminal 12 transmits the speech data for search condition acquisition, which is received from the speech recognition search server 15, to the speech processing apparatus 11 (D4).

The speech processing apparatus 11 receives the speech data for search condition acquisition, and in turn outputs speech for search condition acquisition through the loudspeaker based on the speech data (C5). For example, guide speech saying “What can I do for you?” is outputted. If a user utters a condition for search “Italian” in response to the guide speech, the speech processing apparatus 11 uses the speech data acquisition processing section 31 to acquire the speech data (C6), and uses the speech processing section 33 to perform speech processing for speech recognition search on the acquired speech data (C7). The speech processing apparatus 11 has sensed neither a voluntary nor non-voluntary manipulation in the phone call application A, and therefore recognizes that an application being run is an application other than the phone call application A. The speech processing apparatus 11 therefore changes speech processing, which is performed on speech data, into speech processing for speech recognition search that is an example of speech processing for any purpose other than a phone call. The speech processing apparatus 11 then transmits the speech data, which has undergone the speech processing for speech recognition search, to the handheld terminal 12 (C8). Step C6 is an example of a speech data acquisition step, step C7 is an example of a speech processing step, and step C8 is an example of a speech data transmission step.

The embodiment has been described that when an application being run is an application other than the phone call application A, noise cancel processing for speech recognition search is performed all the time. Alternatively, application identification data for use in identifying the application being run may be transmitted from the handheld terminal 12 to the speech processing apparatus 11. The speech processing apparatus 11 may select and perform speech processing suitable for the application identified with the application identification data.

The handheld terminal 12 transmits speech data, which is received from the speech processing apparatus 11, to the speech recognition search server 15 (D5). On receiving the speech data from the handheld terminal 12, the speech recognition search server 15 performs known speech recognition processing based on the speech data (E2). The speech recognition search server 15 performs known search processing based on recognized speech and position information on the speech processing apparatus 11 (E3), and transmits result-of-search data, which represents a result of the search, to the handheld terminal 12 (E4). At this time, the speech recognition search server 15 also transmits speech data for result-of-search outputting to the handheld terminal 12. For example, message data saying “I'll present you nearby Italian restaurants.” is designated as the speech data for result-of-search outputting. Namely, the speech recognition search server 15 reflects the condition for search “Italian” on the speech data for result-of-search outputting.

The handheld terminal 12 transmits result-of-search data, which is received from the speech recognition search server 15, to the speech processing apparatus 11 (D6). At this time, the handheld terminal 12 also transmits speech data for result-of-search outputting, which is received from the speech recognition search server 15, to the speech processing apparatus 11. The speech processing apparatus 11 receives the speech data for result-of-search outputting, and in turn outputs speech through the loudspeaker based on the speech data (C9). For example, guide speech saying “I'll present you nearby Italian restaurants.” is outputted. On receiving the result-of-search data, the speech processing apparatus 11 displays a result of search based on the result-of-search data (C10). Output speech of the result of search and a display screen view of the result of search are examples of an output interface. Speech data and result-of-search data are appropriately transmitted or received between the speech processing apparatus 11 and speech recognition search server 15 via the handheld terminal 12, whereby a search service using speech recognition is rendered. The speech processing apparatus 11 does not sense a voluntary or non-voluntary manipulation in the phone call application A, and therefore performs speech processing for speech recognition on speech data that is transmitted from the speech processing apparatus 11 to the handheld terminal 12.

When transmitting acquired speech data to the external handheld terminal 12, the speech processing apparatus 11 performs predetermined speech processing on the speech data to be transmitted. As the speech processing, speech processing for a phone call that is an example of speech processing for a phone call and speech processing for speech recognition search that is an example of speech processing for any purpose other than a phone call can be switched and performed. Since the speech processing for a phone call and the speech processing for any purpose other than a phone call can be appropriately switched and performed according to an application that is invoked, the speech processing for a phone call or the speech processing for any purpose other than a phone call can be optimally carried out. The speech processing to be performed on speech data may include, solely or in appropriate combination of the followings: noise cancel processing; echo cancel processing; and automatic gain control processing of gradually increasing a degree of thinning in noise cancel processing.

When sensing a voluntary or non-voluntary manipulation in the phone call application A, the speech processing apparatus 11 performs speech processing for a phone call. Based on whether to have sensed a manipulation specific to the phone call application A, or namely, a manipulation that will not occur in an application other than the phone call application A, speech processing to be performed on speech data is switched to speech processing for a phone call. Therefore, when the phone call application A is run, the speech processing for a phone call can be reliably performed. When the application other than the phone call application A is run, speech processing for any purpose other than a phone call can be reliably performed.

Both speech data for a phone call and speech data for speech recognition that is speech data for any purpose other than a phone call are transmitted or received according to the same communications protocol. Even when an application for any purpose other than a phone call is newly added, speech data relating to the application can be transmitted or received according to the same protocol. This obviates the necessity of developing a dedicated communications protocol every time another application is added. Eventually, a cost for development can be minimized.

The present disclosure is not limited to the aforesaid embodiment but can be applied to various embodiments without a departure from the gist of the disclosure.

The phone call application may be run by the handheld terminal. The speech recognition search application may be run by the speech processing apparatus.

When an application other than the phone call application is invoked, the speech processing apparatus 11, or more particularly, the speech processing section 33 may not perform speech processing. Instead, the handheld terminal 12 or speech recognition search server 15 may perform speech processing. This configuration can suppress a processing load on the speech processing apparatus 11. In addition, the handheld terminal 12 or speech recognition search server 15 can perform specific speech recognition.

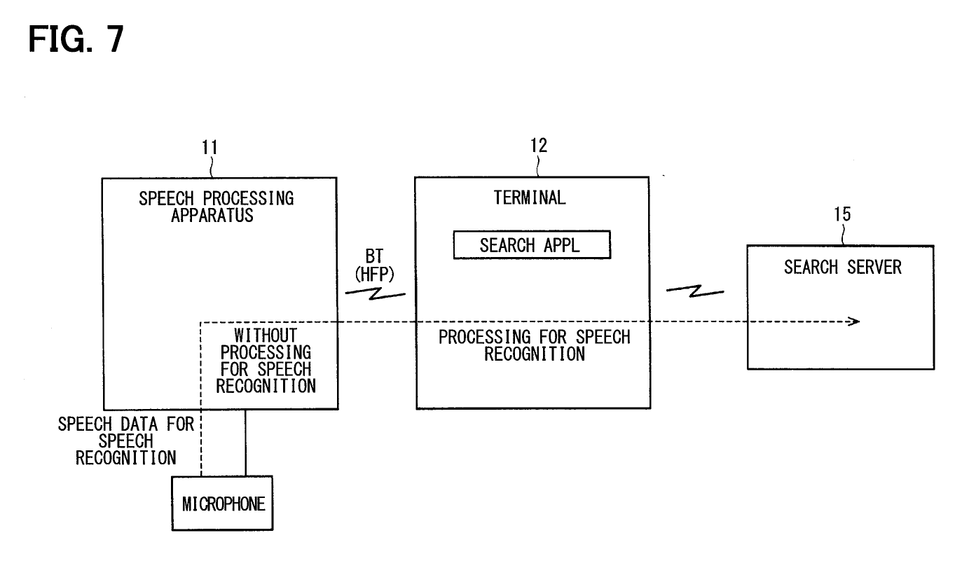

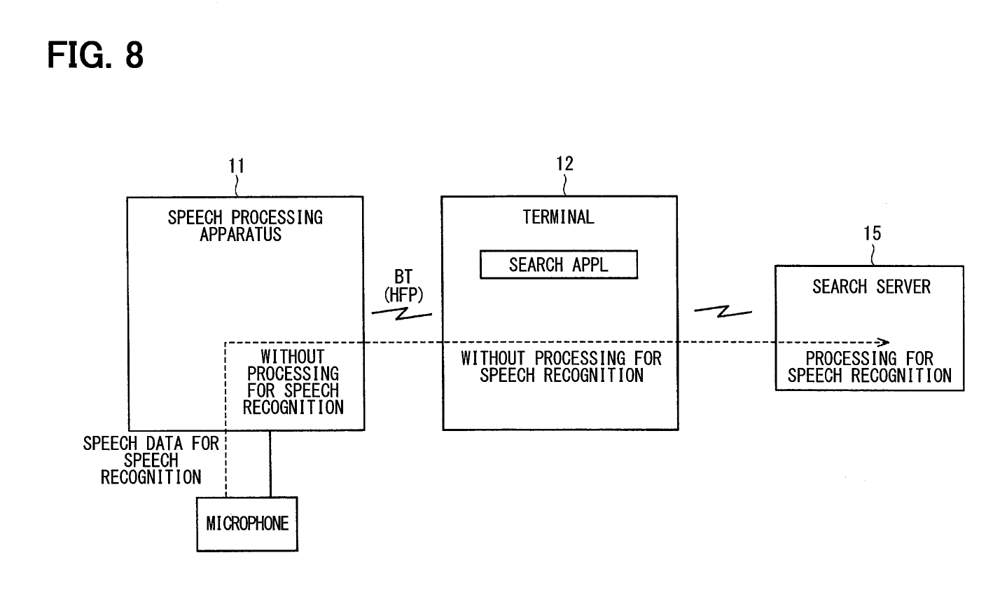

As in FIG. 7, in the speech processing system 10, the speech processing apparatus 11 may not perform speech processing for speech recognition, or namely, signal processing of speech data, but the handheld terminal 12 may perform signal processing for speech recognition. For example, as in FIG. 8, in the speech processing system 10, the speech processing apparatus 11 and handheld terminal 12 may not perform the signal processing for speech recognition but the speech recognition search server 15 may perform the signal processing for speech recognition.

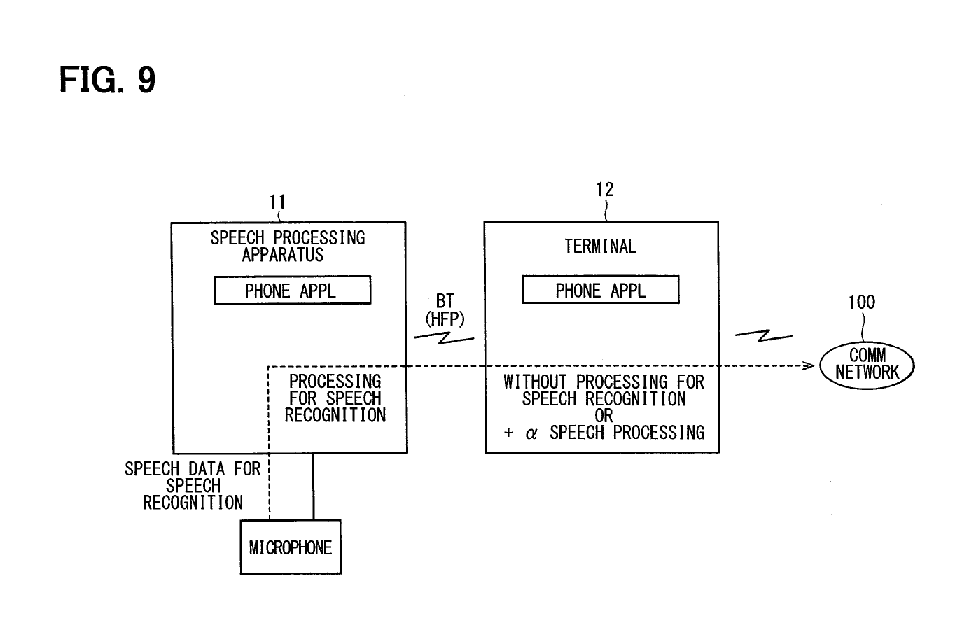

As in FIG. 9, in the speech processing system 10, the phone call application may be installed in each of the speech processing apparatus 11 and handheld terminal 12. The speech processing apparatus 11 may perform speech processing for a phone call on speech data for a phone call, but the handheld terminal 12 may not perform the speech processing for a phone call on the speech data for a phone call or may perform additional speech processing. Otherwise, in the speech processing system 10, the speech processing apparatus 11 may not perform the speech processing for a phone call on the speech data for a phone call or may perform additional speech processing, and the handheld terminal 12 may perform the speech processing for a phone call on the speech data for a phone call, though this configuration is not illustrated.

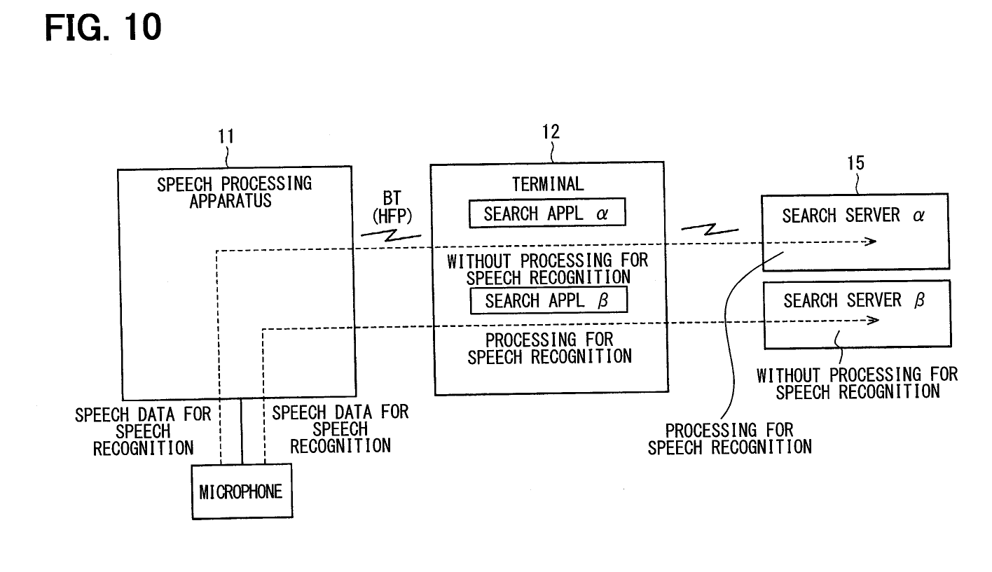

As in FIG. 10, in the speech processing system 10, a speech recognition search application α associated with a speech recognition search server α and a speech recognition search application β associated with a speech recognition search server β may be installed in the handheld terminal 12. For utilizing a search service, which is provided by the speech recognition search server α, by running the speech recognition search application α, the handheld terminal 12 may not perform speech processing for speech recognition on speech data for speech recognition but the speech recognition search server α may perform the speech processing for speech recognition on the speech data for speech recognition. For utilizing a search service, which is provided by the speech recognition search server β, by running the speech recognition search application β, the handheld terminal 12 may perform the speech processing for speech recognition on the speech data for speech recognition but the speech recognition search server β may not perform the speech processing for speech recognition on the speech data for speech recognition. Namely, the speech processing system 10 can change an entity, which performs the speech processing for speech recognition on the speech data, according to the type of speech recognition search application to be employed.

An application other than the phone call application is not limited to the speech recognition search application as long as the application can render a service that requires speech recognition processing.

The speech processing apparatus 11 may include an apparatus installed with an application program having a navigation function. The speech processing apparatus 11 may include an onboard unit that is incorporated in a vehicle or with a handheld wireless unit that is attachable or detachable to or from the vehicle.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A speech processing apparatus comprising:
a speech data acquisition section that acquires speech data;
a speech data transmission section that transmits the speech data, which is acquired by the speech data acquisition section, to an external handheld terminal;
a speech processing section that performs predetermined speech processing on the speech data that is to be transmitted from the speech data transmission section, the predetermined speech processing including noise cancel processing, wherein
the speech processing section switches first speech processing used in phone calls and second speech processing used in other than phone calls so as to perform either the first speech processing or the second speech processing as the predetermined speech processing.

2. The speech processing apparatus according to claim 1, wherein
when sensing either a voluntary manipulation or a non-voluntary manipulation in a phone call application, the speech processing section performs the first speech processing used in phone calls.

3. The speech processing apparatus according to claim 1, wherein
when an application other than a phone call application is invoked, the speech processing section performs the second speech processing used in other than phone calls.

4. The speech processing apparatus according to claim 1, wherein
when a speech recognition application that is an application other than a phone call application is invoked, the speech processing section performs speech processing used in speech recognition that is the second speech processing used in other than phone calls.

5. The speech processing apparatus according to claim 1, wherein:
the speech processing section is enabled to perform the second speech processing used in other than phone calls through which more speech waves are left intact than speech waves left through speech processing used in phone calls; and
when an application other than a phone call application is invoked, the speech processing section performs the second speech processing used in other than phone calls.

6. The speech processing apparatus according to claim 1, wherein
when an application other than the phone call application is invoked, the speech processing section performs no speech processing.

7. The speech processing apparatus according to claim 1, wherein
a communications protocol adopted by the speech data transmission section in transmitting first speech data used in phone calls is identical to a communication protocol adopted by the speech data transmission section in transmitting second speech data used in other than phone calls.

8. The speech processing apparatus according to claim 7, wherein
the speech data transmission section adopts as the communications protocol a profile of a hands-free phone call that is a Bluetooth (registered trademark) communication standard.

9. A speech processing system comprising:
the speech processing apparatus according to claim 1; and
a handheld terminal that is enabled to communicate with the speech processing apparatus.

10. A speech processing method executed by a computer, comprising:
acquiring a speech data;
transmitting the acquired speech data to an external handheld terminal; and
executing predetermined speech processing to the speech data to be transmitted, the predetermined speech processing including noise cancel processing,
wherein in the executing the predetermined speech processing, first speech processing used in phone calls and second speech processing used in other than phone calls are switched as the predetermined speech processing.

11. A program product stored in a non-transitory storage medium to speech processing, the program product including instructions read and executed by a computer, the instructions comprising the speech processing method according to claim 10.
